(19) United States
(12) Patent Application Publication
(10) Pub. No.: US 2015/0160935 A1
(43) Pub. Date: Jun. 11, 2015

(54) MANAGING DEVICE CONFIGURATION INFORMATION

(71) Applicant: Vivint, Inc., Provo, UT (US)

(72) Inventor: James Ellis Nye, Alpine, UT (US)

(21) Appl. No.: 14/561,106

(22) Filed: Dec. 4, 2014

Related U.S. Application Data
(60) Provisional application No. 61/912,965, filed on Dec. 6, 2013.

(51) Int. Cl. G06F 9/445; H04L 12/24; H04L 29/08

(52) U.S. Cl. CPC G06F 8/61; H04L 67/10; H04L 41/0806

(57) ABSTRACT

A computer-implemented method for managing device configuration information is described. In one embodiment, an installation of a device at a premises is detected. Upon detecting the installation of the device at the premises, the device is queried for a device identifier. Upon identifying the device identifier, a repository is queried for device configuration information based on the identified device identifier.

### CROSS REFERENCE

This application claims priority from co-pending U.S. Provisional Patent Application No. 61/912,965 entitled “MANAGING DEVICE CONFIGURATION INFORMATION,” which was filed 6 Dec. 2013, and assigned to the assignee hereof.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of premises automation and premises security products. Advancements in mobile devices allow users to monitor and interact with aspects of a home or business premises from anywhere in the world. Information related to device configuration, however, is not always readily available.

### SUMMARY

According to at least one embodiment, a computer-implemented method for managing device configuration information is described. In one embodiment, an installation of a device at a premises may be detected. Upon detecting the installation of the device at the premises, the device may be queried for a device identifier. Upon identifying the device identifier, a repository may be queried for device configuration information based on the identified device identifier.

A computing device configured for managing device configuration information is also described. The device may include a processor and memory in electronic communication with the processor. The memory may store instructions that may be executable by the processor to detect an installation of a device at a premises, upon detecting the installation of the device at the premises, query the device for a device identifier, and upon identifying the device identifier, query a repository for device configuration information based on the identified device identifier.

A computer-program product for managing device configuration information is also described. The computer-program product may include a non-transitory computer-readable medium that stores instructions. The instructions may be executable by the processor to detect an installation of a device at a premises, upon detecting the installation of the device at the premises, query the device for a device identifier, and upon identifying the device identifier, query a repository for device configuration information based on the identified device identifier.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a device configuration module;

FIG. 3 is a block diagram illustrating one example of an environment for managing device configuration information;

FIG. 4 is a flow diagram illustrating one embodiment of a method for managing device configuration information;

FIG. 5 is a flow diagram illustrating one embodiment of a method for managing device configuration information;

FIG. 6 is a flow diagram illustrating one embodiment of a method for generating a notification upon detecting movement of an asset; and

FIG. 7 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to premises automation and premises security systems. More specifically, the systems and methods described herein relate to managing device configuration information in relation to a premises automation and/or premises security system. Some embodiments of the systems and methods described herein relate to managing device configuration information in relation to an integration of automation and security systems with internet-based and/or subscriber-based media. In some cases, device configuration may be stored in relation to a set-top box configured to deliver media content, which may include one or more devices from internet, satellite, and/or cable media providers. Moreover, the systems and methods described herein may provide managing device configuration information and generating notifications in relation to a vehicle and a home automation system. Furthermore, the systems and methods described herein may provide managing device configuration information and generating notifications in relation to a channel of a media content set top box.

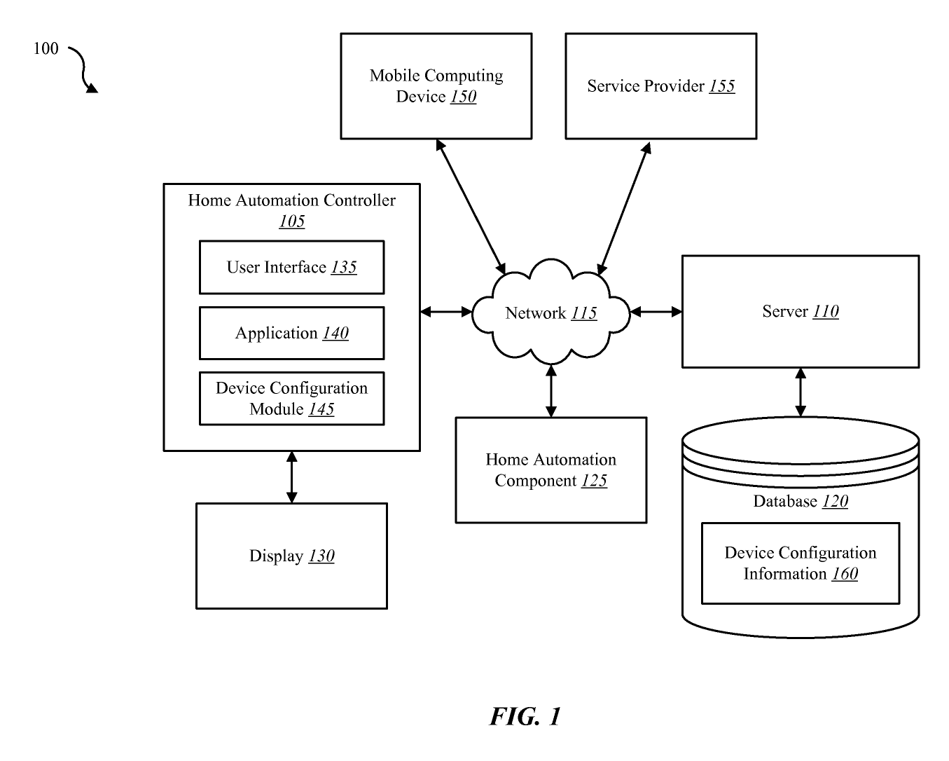

FIG. 1 is a block diagram illustrating one embodiment of an environment 100 in which the present systems and methods may be implemented. In some embodiments, the systems and methods described herein may be performed on a device (e.g., home automation controller 105). The environment 100 may include a home automation controller 105, server 110, a home automation component 125, a display 130, a mobile computing device 150, a service provider 155, and a network 115 that allows the home automation controller 105, the server 110, the mobile computing device 150, home automation controller 105, and home automation component 125 to communicate with one another.

Examples of the service provider 155 include internet media providers, providers of satellite subscription media content, providers of cable subscription media content, and the like. Examples of the home automation controller 105 include a dedicated home automation computing device (e.g., wall-mounted controller), a personal computing device (e.g., laptop, desktop, etc.), a mobile computing device (e.g., tablet computing device, smartphone, etc.), and the like. Although a controller for “home automation” is depicted in one example of environment 100, it is understood that the depicted controller may represent an automation controller for a premises other than a home, such as a place of business. Additionally, or alternatively, controller 105 may represent a security controller for a home or place of business.

Examples of home automation components 125 include home automation sensors, switches, outlets, monitoring equipment, data transmission equipment, storage equipment, and the like. Examples of home automation sensors include a camera sensor, a biometric scanner, audio sensor, forced entry sensor, shock sensor, proximity sensor, boundary sensor, light beam sensor, three-dimensional (3-D) sensor, motion sensor, smoke sensor, glass break sensor, door sensor, window sensor, carbon monoxide sensor, accelerometer, global positioning system (GPS) sensor, Wi-Fi positioning system sensor, capacitance sensor, radio frequency sensor, near-field sensor, temperature sensor, heartbeat sensor, breathing sensor, oxygen sensor, carbon dioxide sensor, brain wave sensor, movement sensor, voice sensor, and the like. Home automation component 125 may represent one or more separate sensors or a combination of two or more sensors in a single device. For example, home automation component 125 may represent one or more camera sensors and one or more motion sensors connected to environment 100. Additionally, or alternatively, home automation component 125 may represent a combination sensor such as both a camera sensor and a motion sensor integrated in the same device. Home automation component 125 may be integrated with a facial recognition system. Although home automation component 125 is depicted as connecting to home automation controller 105 over network 115, in some embodiments, home automation component 125 may connect directly to home automation controller 105.

Additionally, or alternatively, home automation component 125 may be integrated with a home appliance or fixture such as a light bulb fixture, a door knob, a door lock, etc. Home automation component 125 may include an accelerometer to enable home automation component 125 to detect a movement. For example, home automation component 125 may be attached to a set of golf clubs in a garage area. Home automation component 125 may include a wireless communication device enabling home automation component 125 to send and receive data and/or information to and from one or more devices in environment 100. Additionally, or alternatively, home automation component 125 may include a GPS sensor to enable home automation component 125 to determine and/or track a location of home automation component 125. Home automation component 125 may include a proximity sensor to enable sensor to detect a proximity of a person relative to an object to which the sensor is attached and/or associated. In some embodiments, home automation component 125 may include a forced entry sensor (e.g., shock sensor, glass break sensor, etc.) to enable home automation component 125 to detect an attempt to enter an area by force. Home automation component 125 may include a siren to emit one or more frequencies of sound (e.g., an alarm).

In some configurations, the home automation controller 105 may include a user interface 135, application 140, and device configuration module 145. Although the components of the home automation controller 105 are depicted as being internal to the home automation controller 105, it is understood that one or more of the components may be external to the home automation controller 105 and connect to home automation controller 105 through wired and/or wireless connections. In some embodiments, application 140 may be installed on mobile computing device 150 in order to allow a user to interface with a function of home automation controller 105, device configuration module 145, home automation controller 105, and/or server 110.

In some embodiments, home automation controller 105 may communicate with server 110 via network 115. Example of networks 115 include cloud networks, local area networks (LAN), wide area networks (WAN), virtual private networks (VPN), wireless networks (using 802.11, for example), cellular networks (using 3G and/or LTE, for example), etc. In some configurations, the network 115 may include the internet.

It is noted that in some embodiments, the home automation controller 105 may not include a device configuration module 145. For example, home automation controller 105 may include application 140 that allows a device to interface with home automation controller 105 via device configuration module 145 located on another device such as mobile computing device 150 and/or server 110. In some embodiments, home automation controller 105, mobile computing device 150, and server 110 may include a device configuration module 145 where at least a portion of the functions of device configuration module 145 are performed separately and/or concurrently on home automation controller 105, mobile computing device 150, and/or server 110. Likewise, in some embodiments, a user may access the functions of home automation controller 105 and/or server 110 (directly or through home automation controller 105 via device configuration module 145) from mobile computing device 150. For example, in some embodiments, mobile computing device 150 includes a mobile application that interfaces with one or more functions of home automation controller 105, device configuration module 145, and/or server 110.

In some embodiments, server 110 may be coupled to database 120. Database 120 may include device configuration information 160. For example, home automation controller 105 may access (read, write, modify, etc.) device configuration information 160 in database 120 over network 115 via server 110. Database 120 may be internal or external to the server 110. In one example, home automation controller 105 may be coupled directly to database 120, database 120 being internal or external to home automation controller 105. In some embodiments, home automation controller 105, mobile computing device 150, home automation controller 105, and/or server 110 may store a local copy of at least a portion of device configuration information 160 stored on database 120.

Device configuration module 145 may allow a user to replace and/or upgrade a component in a home automation/security system without having to reprogram or re-enter settings for the replaced/upgraded component. For example, a user may replace or upgrade a camera. When the user first installed the camera, settings may have been entered regarding the operation of the camera. These settings may have been stored as part of device configuration information 160. Accordingly, upon replacing/upgrading the camera, the stored settings may be downloaded and applied to the upgraded unit and/or replacement unit. In some configurations, application 140 may enable home automation controller 105 to interface with home automation controller 105 via device configuration module 145 to provide home automation content (e.g., device configuration information 160) to home automation controller 105 and/or mobile computing device 150. Thus, application 140, via the device configuration module 145, may allow users to control and/or configure aspects of their home from mobile computing device 150, for example. Further details regarding the device configuration module 145 are discussed below.

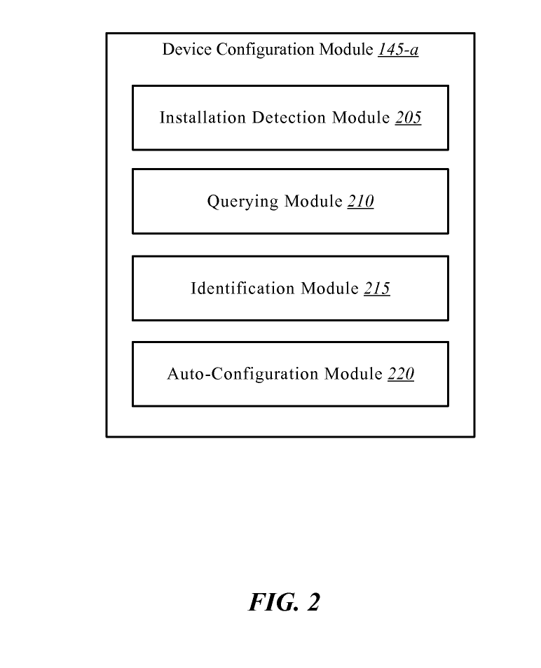

FIG. 2 is a block diagram illustrating one example of a device configuration module 145-a. Device configuration module 145-a may be one example of device configuration module 145 depicted in FIG. 1. As depicted, device configuration module 145-a may include an installation detection module 205, a querying module 210, an identification module 215, and an auto-configuration module 220.

In one embodiment, installation detection module 205 may be configured to detect an installation of a device at a premises such as a home or place of business. For example, installation detection module 205 may detect an installation of a home automation and/or home security system at a home. In some cases, installation detection module 205 may detect an installation of an automation and/or security system at a place of business. Upon detecting the installation of the device at the premises, querying module 210 may query the device being installed for a device identifier. In some cases, the device being installed may be a control panel (e.g., home automation controller 105). Additionally, or alternatively, the device being installed may be a component of a home automation system (e.g., home automation component 125). Upon identifying the device identifier, querying module 210 may query a repository (e.g., database 120) for device configuration information based on the identified device identifier.

In some embodiments, identification module 215 may compare the identified device identifier with entries in the repository. Upon identifying a match between the identified device identifier and an entry in the repository, identification module 215 may determine whether the repository includes device configuration information associated with the matching entry. Upon determining the matching entry is associated with device configuration information stored in the repository, identification module 205 may identify, based on the identified device identifier, the device configuration information stored at the repository that corresponds to the device.

In one embodiment, auto-configuration module 220 may download at least a portion of the identified device configuration information from the repository. Auto-configuration module 220 may use the downloaded device configuration information to configure, in association with home automation controller 105, the device being installed at the premises. In some cases, auto-configuration module 220 may detect a user sending device configuration information to the control panel (or entering the device configuration information at the control panel) for the device being installed at the premises. In some cases, the device being installed may be the control panel itself. Thus, a processor on the control panel may detect the control panel being installed. Additionally, or alternatively, the processor on the control panel may detect a component being installed (e.g., a motion detector, etc.).

Upon detecting the user entering device configuration information for the device being installed at the premises, auto-configuration module 220 may store the entered device configuration information in the repository. Upon detecting the installation of the device at the premises, auto-configuration module 220 may prompt a user to enter device configuration information for the device being installed at the premises. For example, upon determining, based on the identified device identifier, that the repository does not include device configuration information for the device being installed, auto-configuration module 220 may prompt a user to enter device configuration information for the device being installed and store the entered device configuration information at the repository.

In some cases, auto-configuration module 220 may store an association of the identified device identifier with the entered device configuration. Certain devices (e.g., home automation components 125) in the home automation system of FIG. 1 may be programmed to perform certain actions based on recognizing a user at the premises as well as based on not recognizing a user at the premises (e.g., turn on certain lights upon recognizing an occupant of the premises, and sounding an alarm and/or requesting a password or passcode upon not recognizing a person entering the premises). Accordingly, auto-configuration module 220 may store an association of a user identifier with the entered device configuration. The user identifier may include information used to identify an occupant of the premises. For example, the user may carry a device that is used to identify the user when leaving, approaching and/or entering the premises. The device the user carries may include a smartphone, a dedicated user-identifying device, and the like. For instances, the user may carry a device capable of transmitting/receiving radio frequency identifier (RFID), BLUETOOTH®, WIFI®, and/or near-field communication (NFC) communications that identify the user using identifying information (e.g., user name, serial number, etc., transmitted from the device to the home automation system in relation to a predefined perimeter associated with the premises). The user identifier may also include information regarding facial recognition of the user (e.g., sample images of the user), voice recognition of the user (e.g., sample audio of the user's voice), detectable features of the user via feature detection algorithms, and the like.

In some embodiments, auto-configuration module 220 may store an association of a location identifier with the entered device configuration. The location identifier may include information used to identify a location of the device in the premises. In some cases installation detection module 205 may detect a type or classification of the device being installed (e.g., based on the device identifier). Accordingly, installation detection module 205 may determine that the type of the device being installed is a stationary device that is mounted in a location in the premises and designed to remain in that place during its operation.

In some cases, installation detection module 205 may determine that the type of the device being installed is a mobile device designed to be carried and/or attached to an object and/or user in order to track the object/user. Upon determining the type of the device is stationary, auto-configuration module 220 may determine the location in the premises where the device is installed. For example, the device configuration information 160 may include location information indicating the device is being installed in the kitchen area of the premises.

In some cases, the device configuration information 160 may indicate a floor, a room, and/or a relational position (e.g., back of the house, front of the house, east side of the house, etc.) of the device in relation to the premises. For example, the device configuration information 160 may indicate that the device is being installed at the front door on the main floor, in the family room on the main floor, at the back door on the main floor, at the front window of the entry room on the main floor, in a family room on the basement floor, in a bedroom on the second floor, on the exterior of the premises adjacent to the front door, and the like.

Additionally, or alternatively, the device may provide global positioning system (GPS) information regarding the location of the device including latitude and longitude coordinates, elevation, and the like. The device configuration information may include configuration information regarding a data communication network at the premises (e.g., communications enabled by connecting to a network of a wireless router, etc.), configuration information regarding integration of the device with a service of a media provider, in addition to the general and specific settings and programming of each device being installed in the premises.

In one example, a user may install a home automation and security system at the user's home (or place of business). The user may install a home automation controller in the home. The user may also install components that are communicatively coupled to the home automation controller. The home automation components may include automation devices and/or security devices such as cameras, recording equipment, sensors, data communication devices, switches, outlets, sockets, gauges, measurement and monitoring equipment, and the like.

Installation of the control panel may involve the user entering settings and programming for the proper and desired operation of the control panel. For example, the user may enter configuration information that allows the control panel and/or installed components (e.g., home automation components 125) to connect to the data communication network of the home such as a connection to a wireless router at the home. Accordingly, the data communication network configuration settings may be stored in the repository in association with a device identifier of the control panel and/or installed components.

In some cases, a user may enter configuration information that configures the operation of a light switch. For example, the user may configure the light switch to turn on at a certain time during the night time hours during normal operation. The user may configure daytime modes, nighttime modes, sleep-time modes, vacation modes, etc. For example, the user may program a vacation mode to trigger light switches and power outlets to switch on at specified times throughout the day. The user may configure the light switch to interact with a motion detector where upon detecting motion the light switch switches on to turn one or more lights on. In another example, the user may configure settings for the light switch to perform certain actions when the house is detected as being unoccupied and to perform other actions when the house is detected as being occupied. Accordingly, the light switch configuration settings may be stored in the repository in association with a device identifier for the light switch.

In some cases, the user may enter configuration information that connects the control panel to a service provided by a media content provider such as establishing a connection between the control panel and a subscription satellite television set-top box. The connection to the satellite television set-top box may include assigning a video feed from an installed camera to a channel on a channel guide provided by the media content provider via the set-top box. For example, channel 120 may be assigned to the ESPN® sports channel, channel 121 to the DISNEY® channel, and channel 122 may be assigned to the video feed from the installed camera. Accordingly, a user may browse the channel guide and switch to the channel for the installed camera to see a real-time view of the video feed being captured by the camera. Thus, the user may set up recording times for channel 122 in order to capture and record views from the installed camera at specified times.

Likewise, the user may specify to record when the camera detects motion, how long to record when motion is detected, whether to record video or photographs, the frame rate to use for video, the number of photographs to capture, the time between each photograph captured, how long to store recordings before deleting them, where to send the recordings and/or photographs upon detecting motion (e.g., via email, text message, posting to a website, storing at additional storage devices, etc.), and the like. These settings and other similar settings relating to the operation of installed components may be stored at the repository as part of the device configuration information 160.

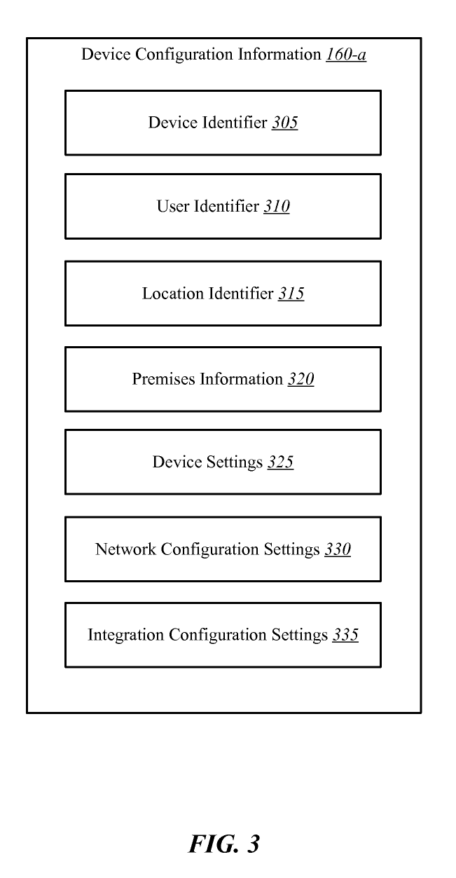

FIG. 3 is a block diagram illustrating one example of an environment 300 for managing device configuration information 160-a. The device configuration information 160-a may be one example of device configuration information 160 stored in database 120 as depicted in FIG. 1. As depicted, the device configuration information 160-a may include device identifier 305, user identifier 310, location identifier 315, premises information 320, device settings 325, network configuration settings 330, and integration configuration settings 335.

With reference to FIGS. 1 and/or 2, a user may install a home automation/security system at a premises such as the user's home or place of business. The installation may include installing one or more control panels (e.g., home automation controller 105) and one or more automation/security components (e.g., home automation component 125). The installation may include configuring the control panel to recognize an installed component. The control panel may recognize the installed component by a device identifier 305. The control panel and/or an installed component may be configured to recognize an occupant of the premises via a user identifier 310. Accordingly, the device configuration information 160-a may include one or more user identifiers 310 (e.g., information relating to image samples and/or detectable features of the user for facial recognition, voice samples for voice recognition, a code emitted by a device carried by the user, etc.).

In some embodiments, the installation may include information regarding the location of the control panel and/or an installed component in relation to the premises. Thus, the device configuration information 160-a may include one or more location identifiers 315. Additionally, installation of the control panel may include programming information about the premises into the control panel (e.g., premises layout, number of floors, number of rooms, room names, number of entry doors, zones, premises address, etc.). Accordingly, the device configuration information 160-a may include premises information 320.

In one embodiment, the installation may include programming and settings for an installed component via the control panel. Thus, the device configuration information 160-a may include device settings 325. The installation may include configuring the control panel and/or one or more installed components to communicate via a data communication network of the premises (e.g., using a wireless router of the premises). Thus, the device configuration information 160-a may include network configuration settings 330. In some cases, the premises may include a device to provide media content such as a set-top box. The installation may include programming and settings to integrate a function of the set-top box with the control panel. Accordingly, the device configuration information 160-a may include integration configuration settings 335.

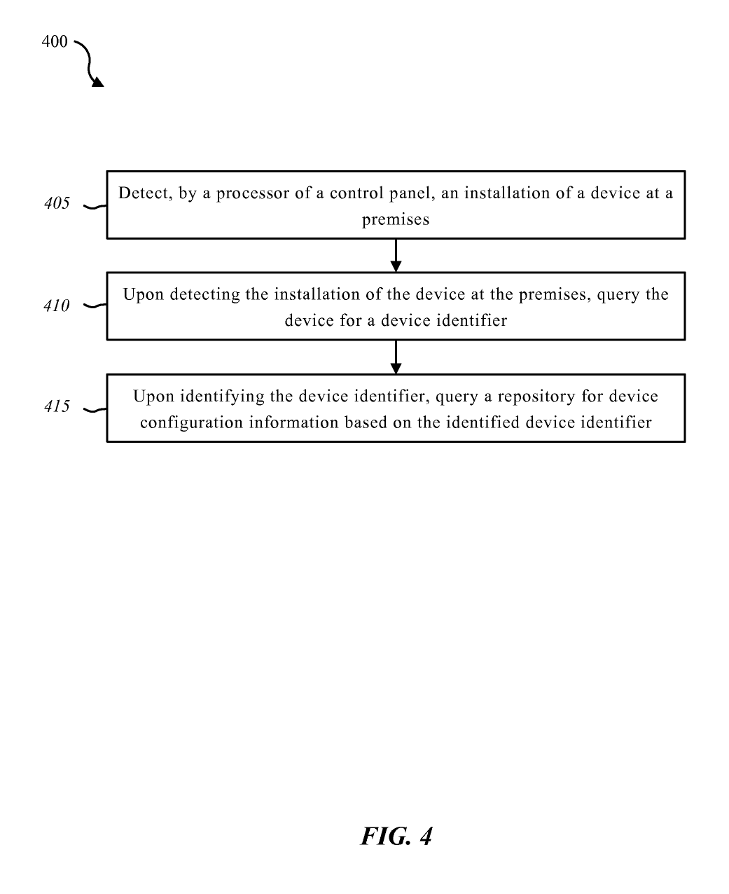

FIG. 4 is a flow diagram illustrating one embodiment of a method 400 for maintaining device configuration information. In some configurations, the method 500 may be implemented by the device configuration module 145 illustrated in FIG. 1 or 2. In some configurations, the method 500 may be implemented in conjunction with the application 140 and/or the user interface 135 illustrated in FIG. 1.

At block 405, an installation of a device at a premises may be detected. At block 410, upon detecting the installation of the device at the premises, the device may be queried for a device identifier. At block 415, upon identifying the device identifier, a repository may be queried for device configuration information based on the identified device identifier.

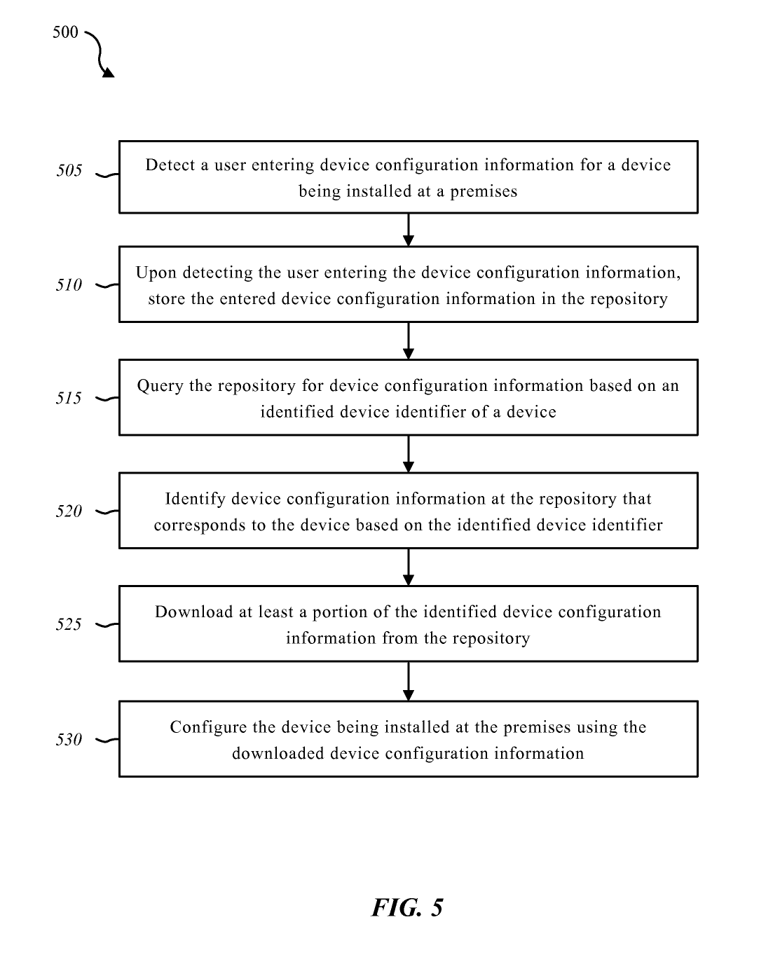

FIG. 5 is a flow diagram illustrating one embodiment of a method 500 for maintaining device configuration information. In some configurations, the method 500 may be implemented by the device configuration module 145 illustrated in FIG. 1 or 2. In some configurations, the method 500 may be implemented in conjunction with the application 140 and/or the user interface 135 illustrated in FIG. 1.

When a user initially installs a device (e.g., control panel, components, etc.), the user may enter configuration information (e.g., programming, settings, etc.) to set up proper and desired operations of the device. This configuration information may be saved in a repository and made accessible for installation of other devices similar to the device that was installed as well as for reinstalling the device that was installed (e.g., replacement of the device, upgrading the device, resetting the device, etc.). For example, a user may install four cameras at the user's home. The user may enter general configuration information that applies to all four cameras. The user may enter this general configuration information one time at the control panel before, during, or after having physically installed the four cameras in their respective locations. The system may store the general configuration information at a repository (e.g., cloud storage network, etc.). Subsequently, the system may automatically use the general configuration information to generally configure the four cameras. Additionally, the user may enter specific configuration information that applies to each camera, respectively. For example, the system may identify a specific camera using location information (e.g., exterior main door camera, etc.), using an identifier assigned to a specific camera (e.g., a serial code may be used to generally identify the component as a camera and a media access control (MAC) address may be used to identify a specific camera, etc.). This information may also be stored at the repository and associated with a particular camera. Thus, the specific configuration information may be stored with information used to identify a specific camera that links the specific configuration information with a specific camera.

Accordingly, at block 505, a user entering device configuration information for the device being installed at the premises may be detected. At block 510, upon detecting the user entering device configuration information for the device being installed at the premises, the entered device configuration information may be stored in the repository. At block 515, a repository for device configuration information may be queried based on the identified device identifier. At block 520, device configuration information at the repository that corresponds to the device may be identified based on the identified device identifier. At block 525, at least a portion of the identified device configuration information may be downloaded from the repository. At block 530, the downloaded device configuration information may be used to configure the device being installed at the premises.

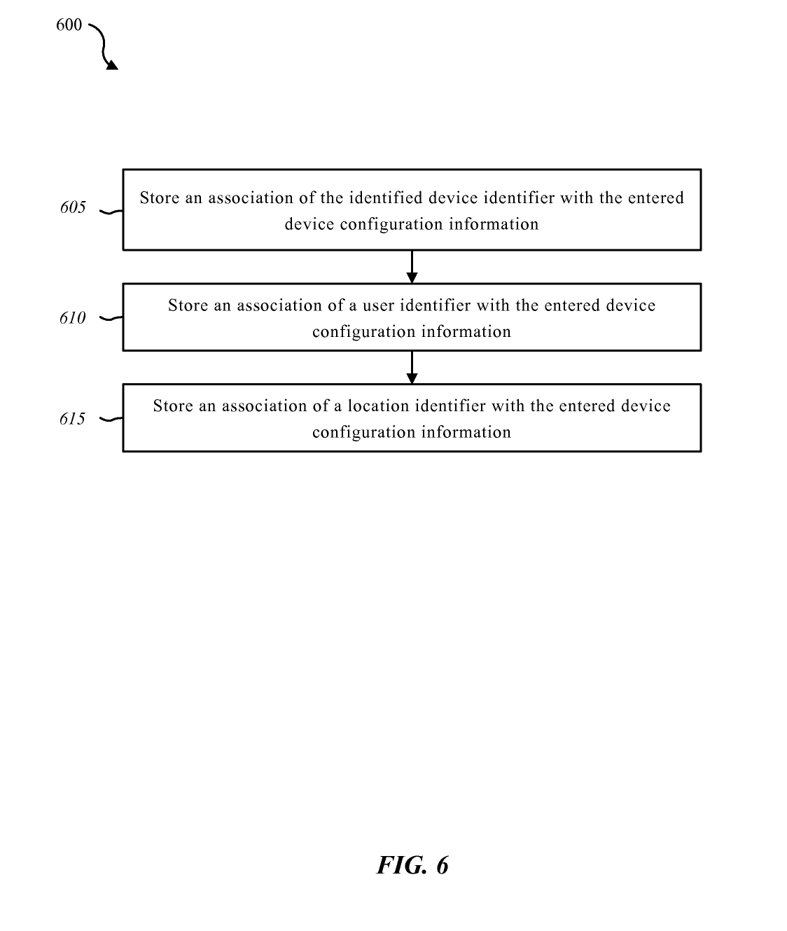

FIG. 6 is a flow diagram illustrating one embodiment of a method 600 for generating a notification upon detecting movement of an asset. In some configurations, the method 600 may be implemented by the device configuration module 145 illustrated in FIG. 1 or 2. In some configurations, the method 600 may be implemented in conjunction with the application 140 and/or the user interface 135 illustrated in FIG. 1.

At block 605, a repository may store an association of an identified device identifier with device configuration information entered by a user. At block 610, a repository may store an association of a user identifier with the entered device configuration information. The user identifier may include information used to identify an occupant of the premises. At block 615, a repository may store an association of a location identifier with the entered device configuration. The location identifier may include information used to identify a location of the device in the premises.

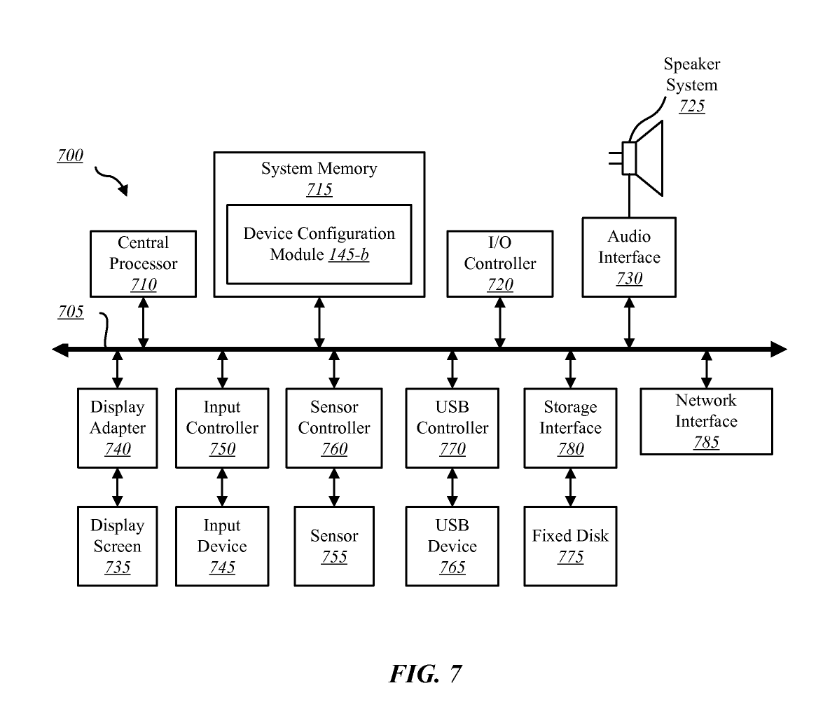

FIG. 7 depicts a block diagram of a controller 700 suitable for implementing the present systems and methods. The controller 700 may be an example of the set top box home automation controller 105, mobile computing device 150, and/or home automation controller 105 illustrated in FIG. 1. In one configuration, controller 700 includes a bus 705 which interconnects major subsystems of controller 700, such as a central processor 715, a system memory 720 (typically RAM, but which may also include ROM, flash RAM, or the like), an input/output controller 725, an external audio device, such as a speaker system 730 via an audio output interface 735, an external device, such as a display screen 735 via display adapter 740, an input device 745 (e.g., remote control device interfaced with an input controller 750), multiple USB devices 765 (interfaced with a USB controller 770), and a storage interface 780. Also included are at least one sensor 755 connected to bus 705 through a sensor controller 760 and a network interface 785 (coupled directly to bus 705).

Bus 705 allows data communication between central processor 715 and system memory 720, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the device configuration module 145-b to implement the present systems and methods may be stored within the system memory 720. Applications (e.g., application 140) resident with controller 700 are generally stored on and accessed via a non-transitory computer readable medium, such as a hard disk drive (e.g., fixed disk 775) or other storage medium. Additionally, applications can be in the form of electronic signals modulated in accordance with the application and data communication technology when accessed via interface 785.

Storage interface 780, as with the other storage interfaces of controller 700, can connect to a standard computer readable medium for storage and/or retrieval of information, such as a fixed disk drive 775. Fixed disk drive 775 may be a part of controller 700 or may be separate and accessed through other interface systems. Network interface 785 may provide a direct connection to a remote server via a direct network link to the Internet via a POP (point of presence). Network interface 785 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 700 wirelessly via network interface 785.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 7 need not be present to practice the present systems and methods. The devices and subsystems can be interconnected in different ways from that shown in FIG. 7. The aspect of some operations of a system such as that shown in FIG. 7 are readily known in the art and are not discussed in detail in this application. Code to implement the present disclosure can be stored in a non-transitory computer-readable medium such as one or more of system memory 720 or fixed disk 775. The operating system provided on controller 700 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for managing device configuration information, the method comprising:
detecting, by a processor of a control panel, an installation of a device at a premises;
upon detecting the installation of the device at the premises, querying, by the processor, the device for a device identifier; and
upon identifying the device identifier, querying, by the processor, a repository for device configuration information based on the identified device identifier.

2. The method of claim 1, further comprising:
identifying device configuration information at the repository that corresponds to the device based on the identified device identifier.

3. The method of claim 2, further comprising:
downloading at least a portion of the identified device configuration information from the repository; and
using the downloaded device configuration information to configure the device being installed at the premises.

4. The method of claim 1, further comprising:
detecting a user entering device configuration information for the device being installed at the premises.

5. The method of claim 4, further comprising:
upon detecting the user entering device configuration information for the device being installed at the premises, storing the entered device configuration information in the repository.

6. The method of claim 1, further comprising:
upon detecting the installation of the device at the premises, prompting a user to enter device configuration information for the device being installed at the premises.

7. The method of claim 6, wherein storing the entered device configuration comprises storing an association of the identified device identifier with the entered device configuration.

8. The method of claim 6, wherein storing the entered device configuration comprises storing an association of a user identifier with the entered device configuration, the user identifier comprising information used to identify an occupant of the premises.

9. The method of claim 6, wherein storing the entered device configuration comprises storing an association of a location identifier with the entered device configuration, the location identifier comprising information used to identify a location of the device in the premises.

10. The method of claim 1, wherein the device configuration information comprises settings and programming of the device being installed in the premises.

11. The method of claim 1, wherein the device configuration information comprises configuration information regarding a data communication network at the premises.

12. The method of claim 1, wherein the device configuration information comprises configuration information regarding integration of the device with a service of a media provider.

13. A computing device configured to managing device configuration information, comprising:
a processor;
memory in electronic communication with the processor; and
instructions stored in the memory, the instructions being executable by the processor to:
detect an installation of a device at a premises;
upon detecting the installation of the device at the premises, query the device for a device identifier; and
upon identifying the device identifier, query a repository for device configuration information based on the identified device identifier.

14. The computing device of claim 13, wherein the instructions are executable by the processor to:
identify device configuration information at the repository that corresponds to the device based on the identified device identifier.

15. The computing device of claim 14, wherein the instructions are executable by the processor to:
download at least a portion of the identified device configuration information from the repository; and
use the downloaded device configuration information to configure the device being installed at the premises.

16. The computing device of claim 13, wherein the instructions are executable by the processor to:
detect a user entering device configuration information for the device being installed at the premises.

17. The computing device of claim 16, wherein the instructions are executable by the processor to:
upon detecting the user entering device configuration information for the device being installed at the premises, store the entered device configuration information in the repository.

18. The computing device of claim 13, wherein the instructions are executable by the processor to:
upon detecting the installation of the device at the premises, prompt a user to enter device configuration information for the device being installed at the premises.

19. The computing device of claim 18, wherein storing the entered device configuration comprises storing an association of the identified device identifier with the entered device configuration.

20. A computer-program product for storing, by a processor, device configuration, the computer-program product comprising a non-transitory computer-readable medium storing instructions thereon, the instructions being executable by the processor to:
detect an installation of a device at a premises;
upon detecting the installation of the device at the premises, query the device for a device identifier; and
upon identifying the device identifier, query a repository for device configuration information based on the identified device identifier.
